(19) United States
(12) Patent Application Publication
(10) Pub. No.: US 2014/0009410 A1
(43) Pub. Date: Jan. 9, 2014

(54) CONDUCTIVE LAYER CAPABLE OF PASSING THROUGH ELECTROMAGNETIC WAVE AND ELECTRONIC DEVICE USING THE SAME

(71) Applicant: SHIH HUA TECHNOLOGY LTD., Zhubei City (TW)

(72) Inventors: PO-SHENG SHIH, Hsinchu (TW); JIA-SHYONG CHENG, Hsinchu (TW)

(73) Assignee: Shih Hua Technology Ltd., Zhubei City (TW)

(21) Appl. No.: 13/729,355

(22) Filed: Dec. 28, 2012

(30) Foreign Application Priority Data
Jul. 5, 2012 (TW) 101124259

(51) Int. Cl. G06F 3/041

(52) U.S. Cl. CPC G06F 3/0412
USPC 345/173; 977/742; 977/952

(57) ABSTRACT

A conductive layer capable of passing through an electromagnetic wave is disclosed in present disclosure. The conductive layer includes a carbon nanotube film including a number of carbon nanotubes. The carbon nanotubes are joined firmly by van der Waals attractive force. The carbon nanotube film further includes a number of micro-gaps between the carbon nanotubes. A transmission rate of the carbon nanotube film to an electromagnetic wave with a frequency from 600 KHz to 2000 MHz is larger than 80%. An electronic device employing the conductive layer is also disclosed.

### CROSS-REFERENCE TO RELATED APPLICATIONS

This application claims all benefits accruing under 35 U.S.C. §119 from Taiwan Patent Application No. 101124259, filed on Jul. 5, 2012 in the Taiwan Intellectual Property Office. This application is also related to application entitled, “HYBRID TOUCH PANEL”, filed **** (Atty. Docket No. US45754). Disclosures of the above-identified applications are incorporated herein by reference.

### BACKGROUND

1. Technical Field

The present disclosure relates to conductive layers capable of passing through electromagnetic wave and electronic devices using the conductive layers.

2. Description of Related Art

Conductive layers are widely used in electronic devices such as a cell phone, MP5, PDA, digital photo frame, GPS, touch panel, and display. A continuous indium tin oxide (ITO) layer is used as the conductive layer in some prior art. Unfortunately, the continuous ITO layer has excellent shielding effect to the electromagnetic wave, which prevents the electromagnetic wave from passing through the conductive layer. Thus, the shielding effect of the continuous ITO layer can restrict some further application of the conductive layer.

What is needed, therefore, is to provide a conductive layer and an electronic device using the conductive layer, in which the conductive layer is capable of passing through the electromagnetic wave.

### BRIEF DESCRIPTION OF THE DRAWINGS

Many aspects of the present disclosure can be better understood with reference to the following drawings. The components in the drawings are not necessarily to scale, the emphasis instead being placed upon clearly illustrating the principles of the present embodiments.

FIG. 1 is a schematic view of an electronic device according to one embodiment.

FIG. 2 shows a scanning electron microscope (SEM) image of a drawn carbon nanotube film used in a conductive layer in the electronic device of FIG. 1.

FIG. 3 shows a SEM image of a pressed carbon nanotube film used in a conductive layer in the electronic device of FIG. 1.

FIG. 4 shows a SEM image of a flocculated carbon nanotube film used in a conductive layer in the electronic device of FIG. 1.

### DETAILED DESCRIPTION

The disclosure is illustrated by way of example and not by way of limitation in the figures of the accompanying drawings in which like references indicate similar elements. It should be noted that references to “another,” “an,” or “one” embodiment in this disclosure are not necessarily to the same embodiment, and such references mean at least one.

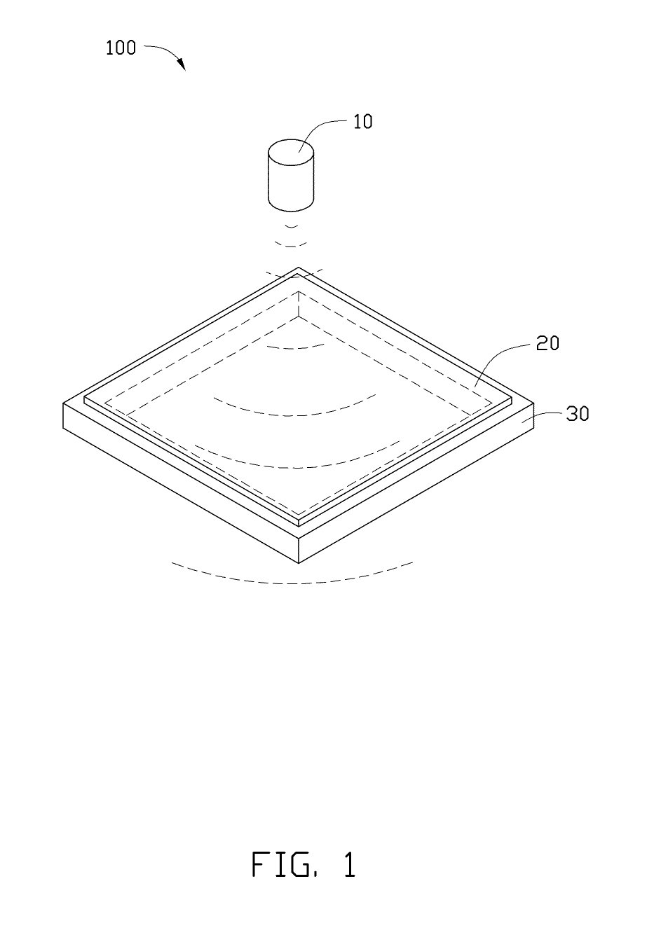

Referring to FIG. 1, an electronic device 100 includes an electromagnetic wave element 10 and a conductive layer 20. The electromagnetic wave element 10 and the conductive layer 20 are opposite to each other. The electromagnetic wave element 10 can be used to produce or receive an electromagnetic wave signal. When the electromagnetic wave element 10 is an electromagnetic wave signal receiver, an electromagnetic wave signal can pass through the conductive layer 20 and then be received by the electromagnetic wave signal receiver. When the electromagnetic wave element 10 is an electromagnetic wave signal producer, an electromagnetic wave signal produced by the electromagnetic wave signal producer can pass through the conductive layer 20.

The conductive layer 20 can be suspended by a supporting frame 30 or stacked on a surface of an insulating substrate directly. In one embodiment, the conductive layer 20 is configured on the supporting frame 30. The supporting frame 30 has a hole and the conductive layer 20 is at least partly suspended by the supporting frame 30. The electromagnetic wave element 10 can be opposite to the hole. The supporting frame 30 can be a metal material. The configuration of the supporting frame 30 will not influence an electromagnetic wave transmission characteristics of the conductive layer 20, because the conductive layer 20 is at least partly suspended.

The electronic device 100 can be a cell phone, MP5, PDA, digital photo frame, GPS, touch panel, display, electronic dictionary, or other electronic device. In one embodiment, the electronic device 100 is a touch-sensitive display. The touch-sensitive display includes a liquid crystal display (LCD) and an electromagnetic touch panel stacked with the LCD. The electromagnetic touch panel is set on a surface of the LCD, wherein the surface is away from a user. The LCD includes at least one conductive layer 20. The at least one conductive layer 20 can be used as an alignment layer or a polarizing layer in the LCD. The electromagnetic touch panel includes a plurality of electromagnetic wave elements 10. The electromagnetic wave element 10 is set to receive an electromagnetic wave signal produced by an electromagnetic pen touching on the touch-sensitive display, and then attain a coordinate data of the touch point in the touch-sensitive display of the electromagnetic pen, and finally control the touch-sensitive display. The electromagnetic wave signal can pass through the conductive layer 20. Therefore, the electromagnetic wave element 10 and the conductive layer 20 can each play a role and not interfere with each other.

The electromagnetic wave element 10 can produce or receive an electromagnetic wave signal with a frequency from 600 KHz to 2000 MHz. The conductive layer 20 is a transparent conductive structure having a plurality of micro-gaps. The plurality of micro-gaps is distributed evenly in the conductive layer 20. The plurality of micro-gaps is capable of passing through the electromagnetic wave signal with a frequency from 600 KHz to 2000 MHz. In one embodiment, the conductive layer 20 is a transparent carbon nanotube layer.

The transparent carbon nanotube layer includes at least one carbon nanotube film. The carbon nanotube film can be a drawn carbon nanotube film, a pressed carbon nanotube film, or a flocculated carbon nanotube film. In one embodiment, the conductive layer 20 includes one drawn carbon nanotube film.

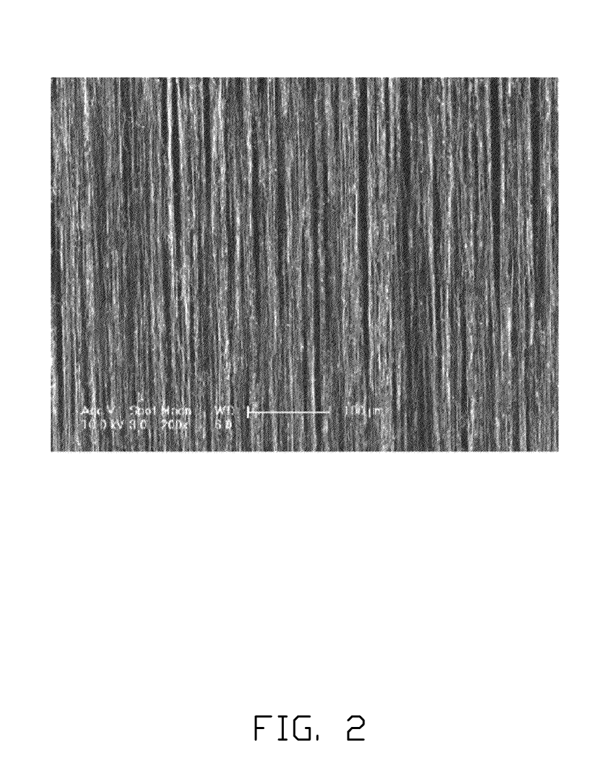

The drawn carbon nanotube film can be obtained by drawing a plurality of carbon nanotubes from a carbon nanotube array. Referring to FIG. 2, the drawn carbon nanotube film is a free-standing structure including a plurality of carbon nanotubes. The term “free-standing structure” can be defined as a structure that does not need to be supported by a substrate and can sustain the weight of itself when it is hoisted by a portion thereof without tearing. The plurality of carbon nanotubes is arranged substantially parallel to a surface of the drawn carbon nanotube film.

A large number of the carbon nanotubes in the drawn carbon nanotube film can be oriented along a preferred orientation, meaning that a large number of the carbon nanotubes in the drawn carbon nanotube film are arranged substantially along the same direction. An end of one carbon nanotube is joined to another end of an adjacent carbon nanotube arranged substantially along the same direction, by van der Waals attractive force. A small number of the carbon nanotubes are randomly arranged in the drawn carbon nanotube film, and has a small if not negligible effect on the larger number of the carbon nanotubes in the drawn carbon nanotube film arranged substantially along the same direction.

The drawn carbon nanotube film has a plurality of micro-gaps between the carbon nanotubes which are arranged substantially along the same direction. A width of the plurality of micro-gaps can be in a range from 10 nanometers to 10 microns. In one embodiment, the width of the plurality of micro-gaps is in a range from 1 micron to 10 microns. In another embodiment, the width of the plurality of micro-gaps is in a range from 5 microns to 10 microns. A ratio of an area of the plurality of micro-gaps to a surface area of the drawn carbon nanotube film can be larger than 80%. In one embodiment, the ratio of the area of the plurality of micro-gaps to the surface of the drawn carbon nanotube film is larger than 90%. In another embodiment, the ratio of the area of the plurality of micro-gaps to the surface area of the drawn carbon nanotube film is larger than 95%.

A light transmission rate of the drawn carbon nanotube film relates to the ratio of the area of the plurality of micro-gaps to the surface area of the drawn carbon nanotube film. Therefore, the light transmission rate of the drawn carbon nanotube film can be larger than 80%. In one embodiment, the light transmission rate of the drawn carbon nanotube film can be larger than 90%. In another embodiment, the light transmission rate of the drawn carbon nanotube film can be larger than 95%.

A transmission rate of the drawn carbon nanotube film to an electromagnetic wave with a frequency from 600 KHz to 2000 MHz can be larger than 80%. In one embodiment, a transmission rate of the drawn carbon nanotube film to an electromagnetic wave with a frequency from 300 MHz to 1500 MHz is larger than 80%. In another embodiment, the transmission rate of the drawn carbon nanotube film to an electromagnetic wave with a frequency from 300 MHz to 1500 MHz is larger than 90%. In another embodiment, the transmission rate of the drawn carbon nanotube film to an electromagnetic wave with a frequency from 300 MHz to 1500 MHz is larger than 95%.

The transparent conductive layer includes a plurality of stacked drawn carbon nanotube films in one embodiment. Each two adjacent drawn carbon nanotube films are joined firmly by van der Waals attractive force therebetween. Define α as an angle between the two orientation directions of the large number of carbon nanotubes in each two adjacent drawn carbon nanotube films. The angle α is equal to or larger than 0 degrees and smaller than or equal to 90 degrees. A transmission rate of the transparent conductive layer to an electromagnetic wave with a frequency from 600 KHz to 2000 MHz can still be larger than 80% in the present embodiment.

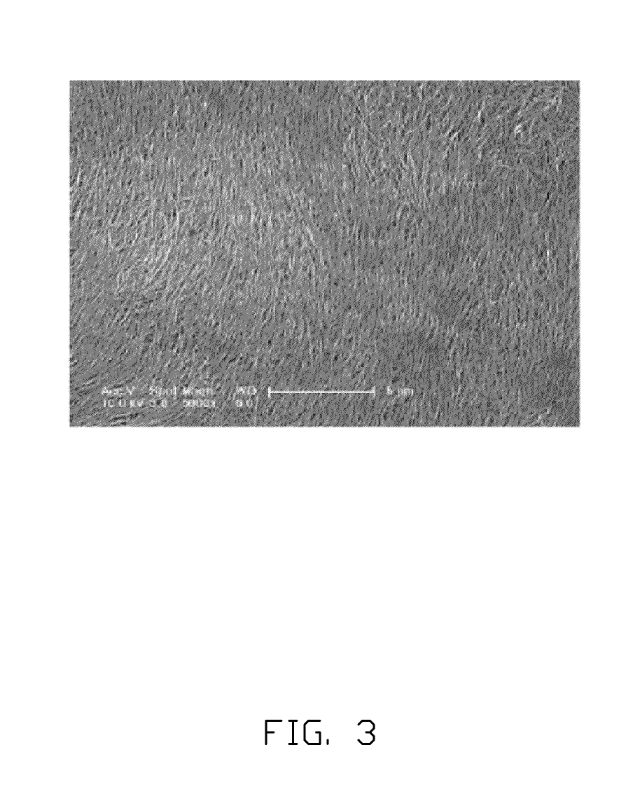

The pressed carbon nanotube film can be obtained by pressing a carbon nanotube array. Referring to FIG. 3, the pressed carbon nanotube film includes a plurality of carbon nanotubes and the plurality of carbon nanotubes can be arranged along a same direction or arranged along different directions. The carbon nanotubes in the pressed carbon nanotube film can rest upon each other. The adjacent carbon nanotubes are combined and attracted to each other by van der Waals attractive force, and can form a free-standing structure. An angle between a primary alignment direction of the carbon nanotubes and a surface of the pressed carbon nanotube film can be in a range from 0 degrees to 15 degrees.

The carbon nanotubes in the pressed carbon nanotube film can be substantially parallel to the surface of the pressed carbon nanotube film if the angle is about 0 degrees. A length and a width of the pressed carbon nanotube film can be set as desired. A thickness of the pressed carbon nanotube film relates to a height of the carbon nanotube array and a pressure of pressing the carbon nanotube array. The thickness of the pressed carbon nanotube film can be in a range from 1 micron to 100 microns.

The pressed carbon nanotube film has a plurality of micro-gaps between the plurality of adjacent carbon nanotubes. A width of the plurality of micro-gaps can be in a range from 10 nanometers to 10 microns.

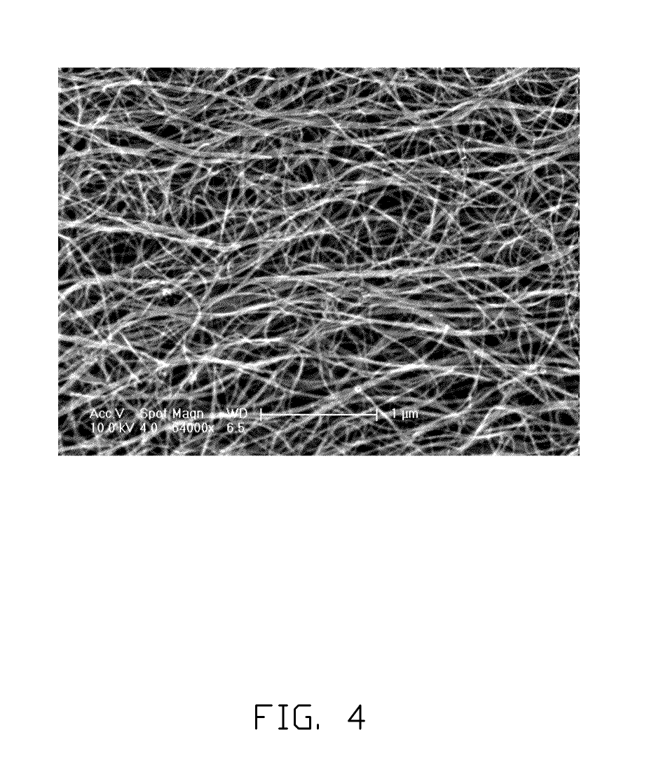

Referring to FIG. 4, the flocculated carbon nanotube film can include a plurality of long, curved, disordered carbon nanotubes entangled with each other and can form a free-standing structure. Thus, the flocculated carbon nanotube film is isotropic. The plurality of carbon nanotubes can be substantially uniformly dispersed in the flocculated carbon nanotube film. The adjacent carbon nanotubes are acted upon by the van der Waals attractive force therebetween, thereby forming an entangled structure.

The flocculated carbon nanotube film has a plurality of micro-gaps between the plurality of adjacent carbon nanotubes. A size of the plurality of micro-gaps can be in a range from 10 nanometers to 10 microns. A length and a width of the flocculated carbon nanotube film can be set as desired. A thickness of the flocculated carbon nanotube film can be in a range from 1 micron to 100 microns.

Due to the excellent mechanical properties of the carbon nanotubes, the conductive layer 20 employing the transparent carbon nanotube layer has good flexibility and mechanical property. Furthermore, due to the plurality of micro-gaps in the transparent carbon nanotube layer, the conductive layer 20 will not form a continuous conductive structure. Thus, the conductive layer 20 is capable of passing through the electromagnetic wave and has no shielding effect to the electromagnetic wave.

The conductive layer 20 can further include an insulating polymer material. The insulating polymer material can be filled in the plurality of micro-gaps of the transparent carbon nanotube layer and form a composite transparent carbon nanotube layer. The addition of the insulating polymer material can improve the mechanical properties of the conductive layer 20. Furthermore, the insulating polymer material can prevent the conductive layer 20 from becoming a continuous conductive structure. Therefore, the addition of the insulating polymer material will not reduce the transmission rate of the transparent carbon nanotube layer to the electromagnetic wave with a frequency from 600 KHz to 2000 MHz. A transmission rate of the composite transparent carbon nanotube layer to the electromagnetic wave with a frequency from 600 KHz to 2000 MHz can still be larger than 80%. Furthermore, the addition of the insulating polymer material will not reduce the light transmission rate of the transparent carbon nanotube layer, because the insulating polymer material is mainly filled in the plurality of micro-gaps of the transparent carbon nanotube layer. A light transmission rate of the composite transparent carbon nanotube layer can still be larger than 80%.

The insulating polymer material can be polyvinyl acetate, polycarbonate, polyacrylate, polysulfone, polystyrene, polyester, polyolefine, or ultraviolet-cured glue.

It is to be understood that the above-described embodiment is intended to illustrate rather than limit the disclosure. Variations may be made to the embodiment without departing from the spirit of the disclosure as claimed. The above-described embodiments are intended to illustrate the scope of the disclosure and not restricted to the scope of the disclosure.

It is also to be understood that the above description and the claims drawn to a method may include some indication in reference to certain steps. However, the indication used is only to be viewed for identification purposes and not as a suggestion as to an order for the steps.

What is claimed is:

1. A conductive layer comprising a porous carbon nanotube layer comprising a plurality of carbon nanotubes joined firmly by van der Waals attractive force therebetween, wherein a transmission rate of the porous carbon nanotube layer to an electromagnetic wave with a frequency from 600 KHz to 2000 MHz is larger than 80%.

2. The conductive layer as claimed in claim 1, wherein the porous carbon nanotube layer comprises at least one drawn carbon nanotube film comprising a plurality of carbon nanotubes arranged along a same direction.

3. The conductive layer as claimed in claim 1, wherein the porous carbon nanotube layer comprises at least one pressed carbon nanotube film comprising a plurality of carbon nanotubes arranged along a same direction or along different directions, and an angle between a primary alignment direction of the carbon nanotubes and a surface of the pressed carbon nanotube film is 0 degree to approximately 15 degrees.

4. The conductive layer as claimed in claim 1, wherein the porous carbon nanotube layer comprises at least one flocculated carbon nanotube film comprising a plurality of long, curved, disordered carbon nanotubes entangled with each other.

5. The conductive layer as claimed in claim 2, wherein the drawn carbon nanotube film comprises a plurality of micro-gaps between the adjacent carbon nanotubes of the plurality of carbon nanotubes.

6. The conductive layer as claimed in claim 5, wherein a width of the plurality of micro-gaps is in a range from 10 nanometers to 10 microns.

7. The conductive layer as claimed in claim 5, wherein a width of the plurality of micro-gaps is in a range from 1 micron to 10 microns.

8. The conductive layer as claimed in claim 5, wherein a ratio of an area of the plurality of micro-gaps to a surface area of the drawn carbon nanotube film is larger than 80%.

9. The conductive layer as claimed in claim 5, wherein a ratio of an area of the plurality of micro-gaps to a surface area of the drawn carbon nanotube film is larger than 90%.

10. The conductive layer as claimed in claim 8, wherein a transmission rate of the drawn carbon nanotube film to an electromagnetic wave with a frequency from 300 MHz to 1500 MHz is larger than 80%.

11. The conductive layer as claimed in claim 9, wherein a transmission rate of the drawn carbon nanotube film to an electromagnetic wave with a frequency from 300 MHz to 1500 MHz is larger than 90%.

12. The conductive layer as claimed in claim 5, further comprising a polymer material filled in the plurality of micro-gaps.

13. The conductive layer as claimed in claim 12, wherein the polymer material is selected from the group consisting of polyvinyl acetate, polycarbonate, polyacrylate, polysulfone, polystyrene, polyester, polyolefine, and ultraviolet-cured glue.

14. A conductive layer comprising a carbon nanotube film and a polymer material, the carbon nanotube film comprising a plurality of carbon nanotubes and a plurality of micro-gaps therebetween, the polymer material being filled in the plurality of micro-gaps, wherein a transmission rate of the conductive layer to an electromagnetic wave with a frequency from 600 KHz to 2000 MHz is larger than 80%.

15. The conductive layer as claimed in claim 14, a ratio of an area of the plurality of micro-gaps to an area of surface of the carbon nanotube film is larger than 80%.

16. The conductive layer as claimed in claim 14, wherein the plurality of carbon nanotubes in the carbon nanotube film are arranged substantially along a same direction.

17. An electronic device comprising an electromagnetic wave element and a conductive layer opposite to the electromagnetic wave element, the electromagnetic wave element being configured to produce or receive an electromagnetic wave signal, wherein the conductive layer comprises a porous carbon nanotube layer and a transmission rate of the porous carbon nanotube layer to an electromagnetic wave with a frequency from 600 KHz to 2000 MHz is larger than 80%.

18. The electronic device as claimed in claim 17, wherein the porous carbon nanotube layer comprises at least one drawn carbon nanotube film comprising a plurality of carbon nanotubes arranged substantially along a same direction and a plurality of micro-gaps therebetween.

19. The electronic device as claimed in claim 17, further comprising a liquid crystal display and an electromagnetic touch panel stacked with the liquid crystal display, the electromagnetic touch panel being set on a surface of the liquid crystal display, wherein the surface is away from a user, the conductive layer is comprised in the liquid crystal display, and the electromagnetic wave element is comprised in the electromagnetic touch panel.

20. The electronic device as claimed in claim 17, wherein the conductive layer further comprises a polymer material compound with the porous carbon nanotube layer, and a transmission rate of the conductive layer to the electromagnetic wave with a frequency from 600 KHz to 2000 MHz is larger than 80%.
